(19) United States
(12) Patent Application Publication
(10) Pub. No.: US 2010/0074189 A1
(43) Pub. Date: Mar. 25, 2010

(54) Scheduling metric for delay sensitive traffic

(75) Inventors: Haiming Wang, Beijing (CN); Jing Han, Beijing (CN)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/284,802

(22) Filed: Sep. 24, 2008

(51) Int. Cl. H04W 72/10

(52) U.S. Cl. 370/329; 455/512

(57) ABSTRACT

Disclosed is a method, a computer-readable memory medium and apparatus to create a combined priority list that comprises both uplink users and downlink users ordered by priority for use in scheduling user transmissions based on their respective priority locations in the combined priority list. In an exemplary embodiment a first set of users are retransmission users, a second set of users are delay sensitive users, and a third set of users are other users that are neither retransmission users or delay sensitive users. The set of retransmission users has a higher priority than the set of delay sensitive users, which in turn has a higher priority than the set of other users.

### TECHNICAL FIELD

The exemplary and non-limiting embodiments of this invention relate generally to wireless communication systems, methods, devices and computer programs and, more specifically, relate to techniques for scheduling users, also referred to herein as user equipment, for operation in a wireless communication system.

### BACKGROUND

The following abbreviations which may appear in the following text and/or the drawing figures are defined as follows:

3GPP third generation partnership project

UTRAN universal terrestrial radio access network

EUTRAN evolved UTRAN (LTE)

LTE long term evolution

Node B base station

eNB EUTRAN Node B (evolved Node B)

UE user equipment

UL uplink (UE towards eNB)

DL downlink (eNB towards UE)

EPC evolved packet core

MME mobility management entity

S-GW serving gateway

HO handover

PHY physical

RLC radio link control

RRC radio resource control

RRM radio resource management

MAC medium access control

PDCP packet data convergence protocol

O&M operations and maintenance

FDD frequency division duplex

FDMA frequency division multiple access

HARQ hybrid automatic repeat request

OFDMA orthogonal frequency division multiple access

SC-FDMA single carrier, frequency division multiple access

TDD time division duplex

QoS quality of service

VoIP voice over internet protocol

A communication system known as evolved UTRAN (EUTRAN, also referred to as UTRAN-LTE or as E-UTRA) is currently under development within the 3GPP. The DL access technique will be OFDMA, and the UL access technique will be SC-FDMA.

One specification of interest is 3GPP TS 36.300, V8.5.0 (2008-05), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), incorporated by reference herein in its entirety.

FIG. 1 reproduces FIG. 4 of 3GPP TS 36.300, and shows the overall architecture of the E-UTRAN system. The EUTRAN system includes eNBs, providing the EUTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1MME interface and to a Serving Gateway (SGW) by means of a S1U interface. The S1 interface supports a many to many relationship between MMEs/Serving Gateways and eNBs.

The eNB hosts the following functions:

functions for Radio Resource Management: Radio Bearer Control, Radio Admission Control, Connection Mobility Control, Dynamic allocation of resources to UEs in both uplink and downlink (scheduling);

IP header compression and encryption of the user data stream;

selection of a MME at UE attachment;

routing of User Plane data towards Serving Gateway;

scheduling and transmission of paging messages (originated from the MME);

scheduling and transmission of broadcast information (originated from the MME or O&M); and

measurement and measurement reporting configuration for mobility and scheduling.

An important aspect of the RRM functionality is a UE scheduling metric, as the scheduling metric has a direct impact on the overall system efficiency.

Furthermore, it should be appreciated that delay factor is an important criterion in order to measure the required QoS for delay sensitive traffic. For both the UL and the DL the delay requirements may be the same, although for other factors this may not be true.

### SUMMARY

The foregoing and other problems are overcome, and other advantages are realized, by the use of the exemplary embodiments of this invention.

In a first aspect thereof the exemplary embodiments of this invention provide a method that comprises creating a combined priority list that comprises both uplink users and downlink users ordered by priority; and scheduling user transmissions based on their respective priority locations in the combined priority list.

In a further aspect thereof the exemplary embodiments of this invention provide a computer-readable medium that stores computer program instructions, the execution of which result in operations that comprise creating a combined priority list that comprises both uplink users and downlink users ordered by priority; and scheduling user transmissions based on their respective priority locations in the combined priority list.

In another aspect thereof the exemplary embodiments of this invention provide an apparatus that comprises a controller configured to create a combined priority list that comprises both uplink users and downlink users ordered by priority for use in scheduling user transmissions based on their respective priority locations in the combined priority list.

In another aspect thereof the exemplary embodiments of this invention provide an apparatus that comprises means for establishing a first priority list for a first set of users that are retransmission users, for establishing a second priority list for a second set of users that are delay sensitive users, and for establishing a third priority list for a third set of users that are neither retransmission users or delay sensitive users. The apparatus further comprises means for creating from the first, second and third priority lists a combined priority list that comprises both uplink users and downlink users ordered by priority.

### BRIEF DESCRIPTION OF THE DRAWINGS

In the attached Drawing Figures:

FIG. 1 reproduces FIG. 4 of 3GPP TS 36.300, and shows the overall architecture of the E-UTRAN system.

FIG. 2 shows a simplified block diagram of various electronic devices that are suitable for use in practicing the exemplary embodiments of this invention.

FIG. 3 shows an example of UL and DL priority scheduling lists.

FIG. 4 shows an example of a first embodiment of a combined priority list for retransmission users, where UL retransmission users are given a higher priority that DL retransmission users.

FIG. 5 shows an example of a second embodiment of a combined priority list for retransmission users, where UL and DL priority lists are re-ordered globally in terms of retransmission number.

FIG. 6 shows an example of a first embodiment of a combined priority list for delay sensitive users, where UL and DL users are interleaved in the combined list to achieve fairness, and where selection between an UL user and a DL user is based on a time remaining for transmission to occur.

FIG. 7 shows an example of a second embodiment of a combined priority list for delay sensitive users, where there is determined a most delay urgent user, and where highest priority is assigned to a user set which includes the identified most delay urgent user and those users with higher priority in the same direction (UL or DL).

FIG. 8 shows an example of a first embodiment of a combined priority list for other users, where UL and DL users are alternately selected to achieve fairness.

FIG. 9 shows an example of a second embodiment of a combined priority list for other users, where UL and DL users are selected in a random manner to achieve fairness.

FIG. 10 presents a non-limiting example implementation for achieving a joint UL/DL priority list.

FIG. 11 is a logic flow diagram that illustrates the operation of a method, and a result of execution of computer program instructions, in accordance with the exemplary embodiments of this invention.

### DETAILED DESCRIPTION

It may be the case in some systems that there is a similar/same scheduling metric for both UL and DL delay sensitive traffic, such as VoIP traffic. For example, the scheduling metric may be summarized as:

1st priority: retransmission users;

2nd priority: delay sensitive users (those sufficiently close to the used delay budget); and

3rd priority: other users.

A problem that may arise is that there may be an insufficient amount of control and data resources to schedule all users at the same time. Although the UL or DL may each individually obtain its own best performance in terms of the defined scheduling metric, it may not be clear on how one should merge independent UL/DL priorities into one joint list that provides optimum performance for at least delay sensitive traffic (e.g., for VoIP traffic).

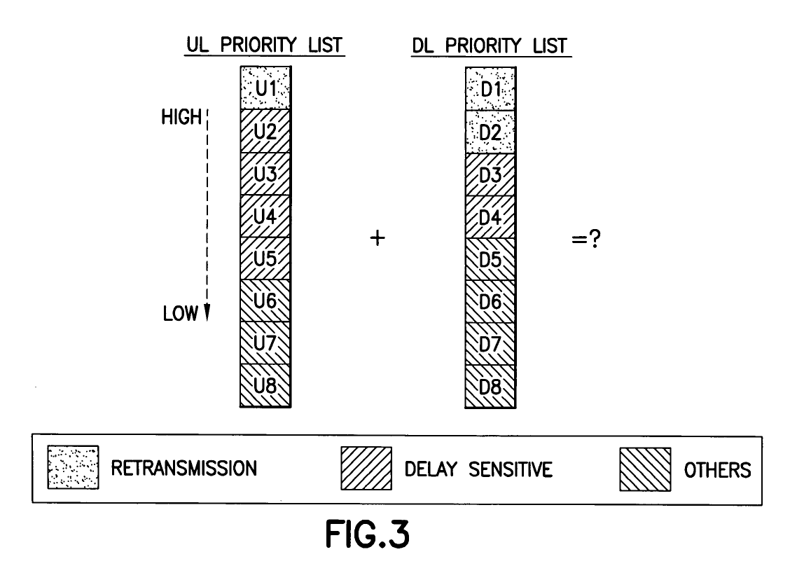

FIG. 3 shows an example of separate UL and DL priority scheduling lists. In this example there is one UL retransmission user and two DL retransmission users, four UL delay sensitive users and two DL delay sensitive users, and three UL other users (lowest priority) and four DL other users. As can be appreciated, at least one problem that arises is how to construct a single, joint UL and DL scheduling priority list from these separate lists.

The exemplary embodiments of this invention address and solve the problems discussed above by providing a joint scheduling metric for delay sensitive traffic that combines the nature of each scheduling group (e.g., retransmission traffic, delay sensitive traffic and other traffic, such as best effort traffic).

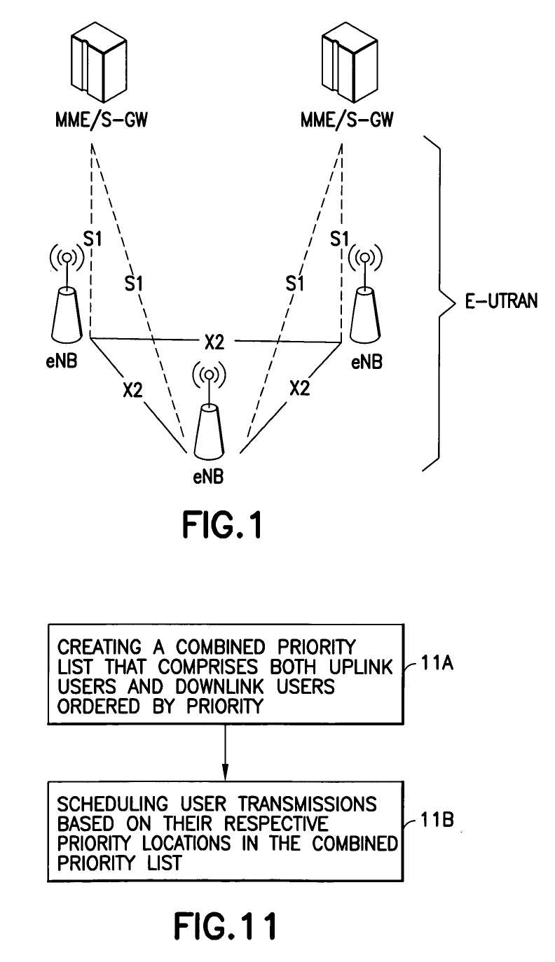

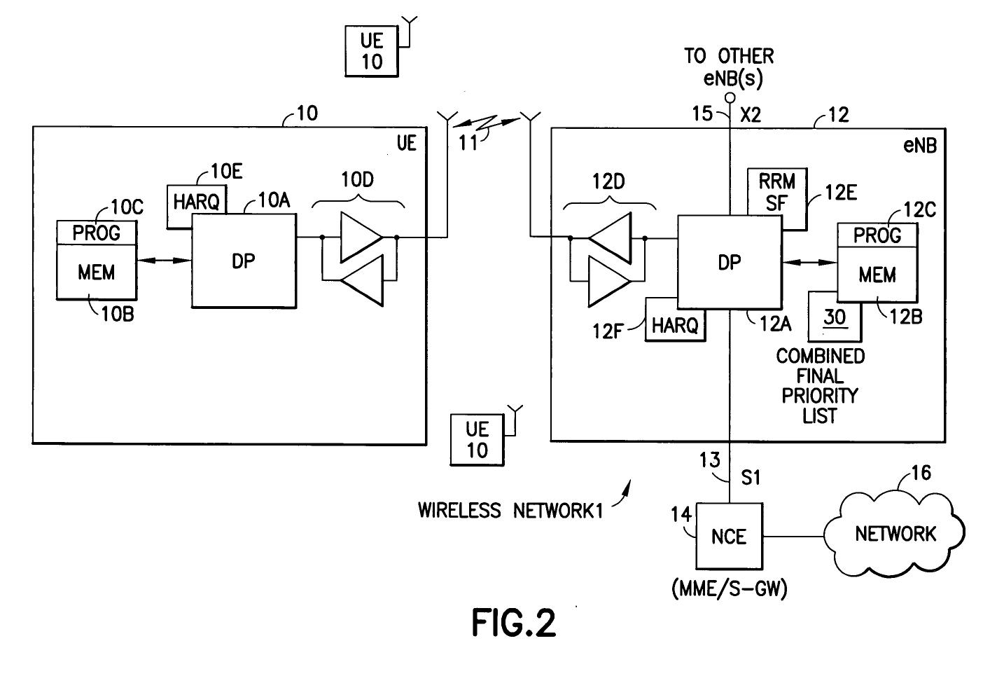

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication with an apparatus, such as a mobile communication device which may be referred to as a UE 10, via a network access node, such as a Node B (base station), and more specifically an eNB 12. The network 1 may include a network control element (NCE) 14 that may include the MME/S-GW functionality shown in FIG. 1, and which provides connectivity with a network 16, such as a telephone network and/or a data communications network (e.g., the internet). The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications 11 with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as the S1 interface shown in FIG. 1. The eNB 12 may also be coupled via a data/control path 15 to at least one other eNB. The path 15 may be implemented as the X2 interface shown in FIG. 1.

At least the PROG 12C is assumed to include program instructions that, when executed by the associated DP 12A, enable the electronic device to operate in accordance with the exemplary embodiments of this invention, as will be discussed below in greater detail.

For the purposes of describing the exemplary embodiments of this invention the eNB 12 may be assumed to include a RRM scheduling function or unit (RRM SF) 12E that operates in accordance with the exemplary embodiments of the invention. The RRM SF 12E may be implemented as computer software executable by the DP 12A of the eNB 12, or by hardware, or by a combination of software and hardware (and firmware). It may also be the case that the UE 10 includes a HARQ function 10E, and the eNB 12 also includes a HARQ function 12F. The operation of the HARQ functions 10E and 12F can result in the need to make one or more retransmissions (in the UL or DL) of packet and other data that was not correctly received.

Typically there will be a plurality of the UEs 10 associated with different users, and these UEs 10 will have differing UL and DL traffic requirements. For example, some of these UEs 10 may be associated with delay sensitive traffic, such as VoIP traffic, while others may be associated with other traffic, such as a best effort traffic. Still others of the UEs 10 may be associated with HARQ retransmissions (either a first, second, third, etc., retransmission).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A, 12A may be of any type suitable to the local technical environment, and may include one or more of general purpose computers, special purpose computers, microprocessors, digital signal processors (DSPs) and processors based on multi-core processor architectures, as non-limiting examples.

Discussed now in further detail are the exemplary embodiments of this invention as they pertain to providing an enhanced UL/DL scheduling function using a joint (combined) UL and DL priority order. The UL and DL priority order may be expressed as a list, an array, or as a table, as three non-limiting examples. In general, any suitable type of data structure may be used for expressing the UL and DL priority order. As such, and while this data structure may be referred to below for convenience as a “list”, it should be appreciated that the UL and DL priority order may be expressed in any suitable format, and that the UL and DL priority order may be referred to for convenience, and not by way of limitation, as an UL and DL priority list.

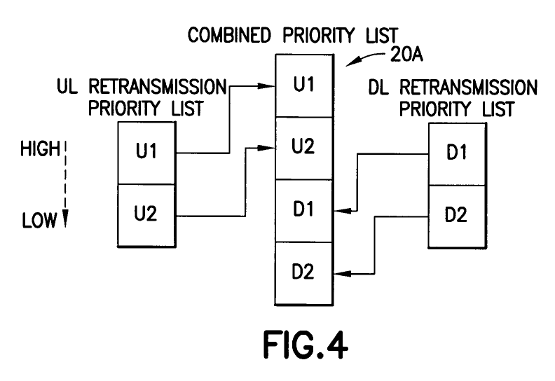

In one embodiment that pertains to the retransmission UEs 10, the UL priority is made to be higher than the DL priority because synchronous HARQ (used in the UL) is more urgent than asynchronous HARQ (used in the DL). This is shown in the example of FIG. 4, where two UL retransmission users are placed in the combined (final) priority list 20A before two DL retransmission users.

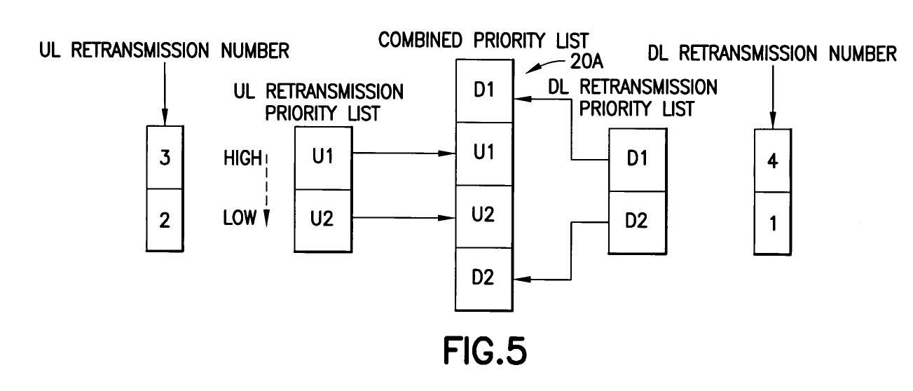

In another embodiment that pertains to the retransmission UEs 10, shown in FIG. 5, the UL and DL priority lists are re-ordered globally in terms of retransmission number (i.e., whether this is a first HARQ retransmission, or a second, etc.). In an exemplary embodiment high retransmission number UEs 10 (whether UL or DL) are given a higher priority (more urgent) than lower transmission number UEs 10 in the final list 20A.

For a case where the retransmission numbers of an UL and a DL UE 10 are the same, priority may be given to the UL UE 10 versus the DL UE 10, in accordance with the first embodiment shown in FIG. 4.

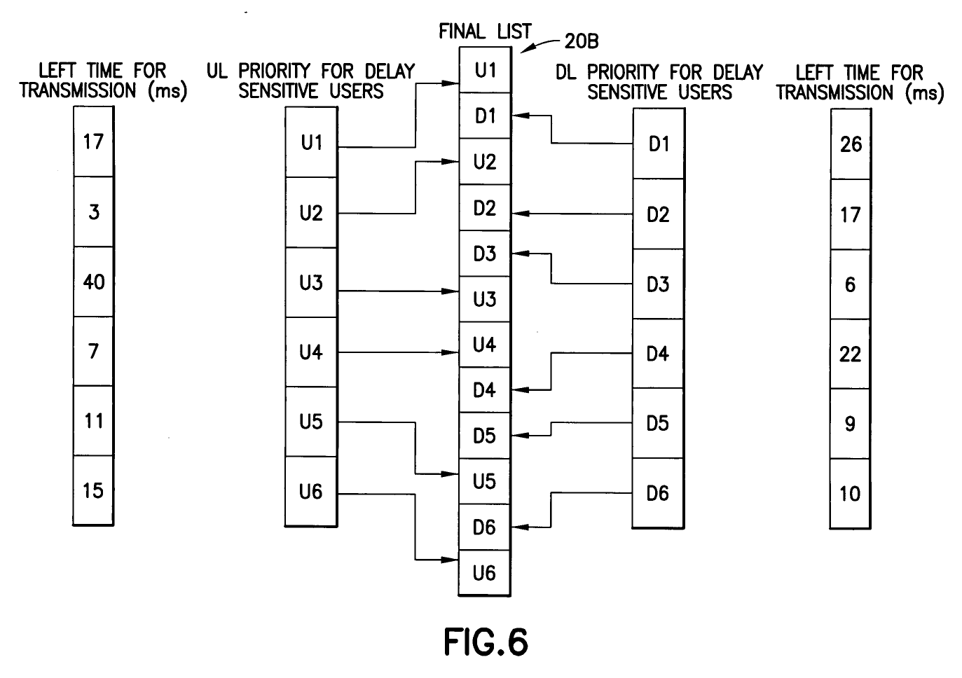

In one exemplary embodiment shown in FIG. 6, which pertains to the delay sensitive UEs 10, a crossover or interleaving is performed between the same scheduling order for the UL and the DL in order to achieve fairness. Whether the UL user or the DL user is chosen first is determined by a delay value, where the user having the largest delay value (expressed in the figure as the time left or remaining for transmission in milliseconds) is given the highest priority. For example, UL user 1 has less time remaining for transmission than DL user 1 (17 ms versus 26 ms), and so the UL user 1 is placed in the final (combined) list 20B before DL user 1. On the other hand, UL user 3 has more time remaining for transmission than DL user 3 (40 ms versus 6 ms), and so the UL user 3 is placed in the final (combined) list 20B after DL user 3.

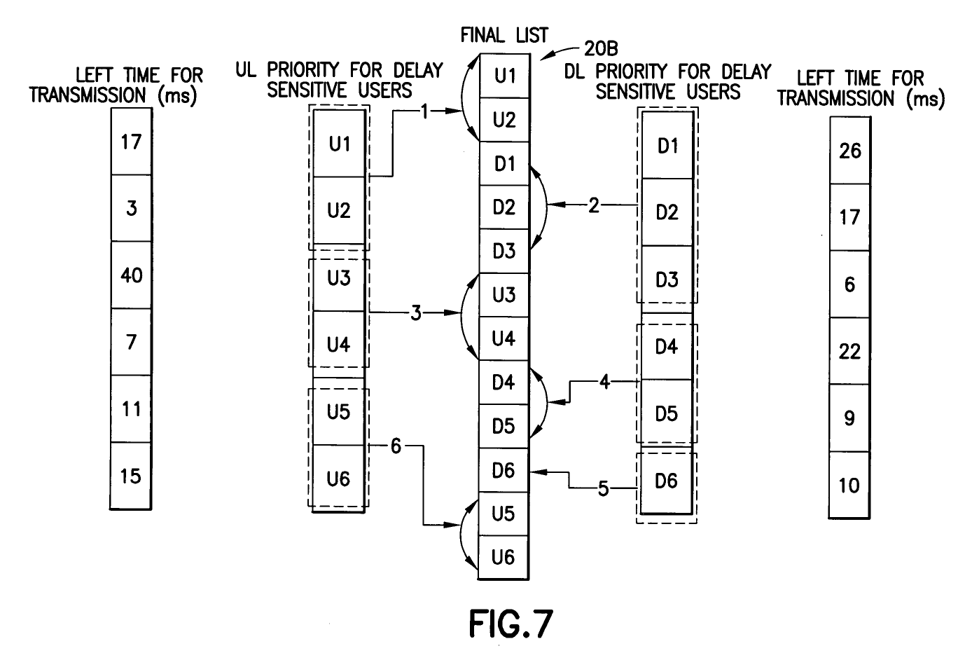

Another exemplary embodiment shown in FIG. 7, which also pertains to the delay sensitive UEs 10, may be characterized as being “most urgent user” driven. That is, among all the UL and DL users the RRM SF 12E of FIG. 2 determines the most delay urgent user, and then gives the first priority to the user set which includes this user and the users with higher priority in the same direction (UL or DL). This process this then repeated until all users are scheduled. In this non-limiting example U2 is selected first, as U2 has a time left for transmission of 3 ms, and so U1 and U2 are scheduled first. The second most time-critical user is D3, as D3 has a time left for transmission of 6 ms, and so D1, D2 and D3 are scheduled next. This process continues in the same manner until all of the UL and DL users are scheduled into the final priority list 20B.

Discussed now is the scheduling of UEs 10 associated with the class of others, such as best effort QoS users. One exemplary embodiment may be referred to as a “zigzag” or interleaved scheme, which gives priority to UL and DL alternately for fairness.

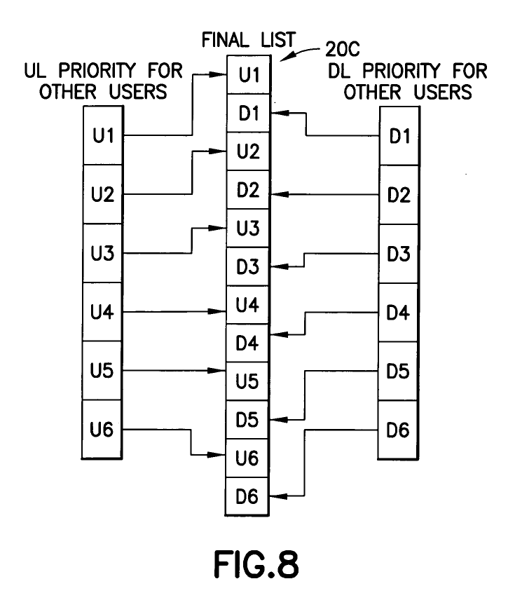

Referring to FIG. 8, this exemplary embodiment alternates between the UL and DL users and allocates positions in the combined final list 20C taking first the highest priority UL user, then the highest priority user from the DL list, and so forth until all UEs 10 are allocated to the final list. Note that it is within the scope of these exemplary embodiments to allocate the first position to the DL user, and second position to the UL user.

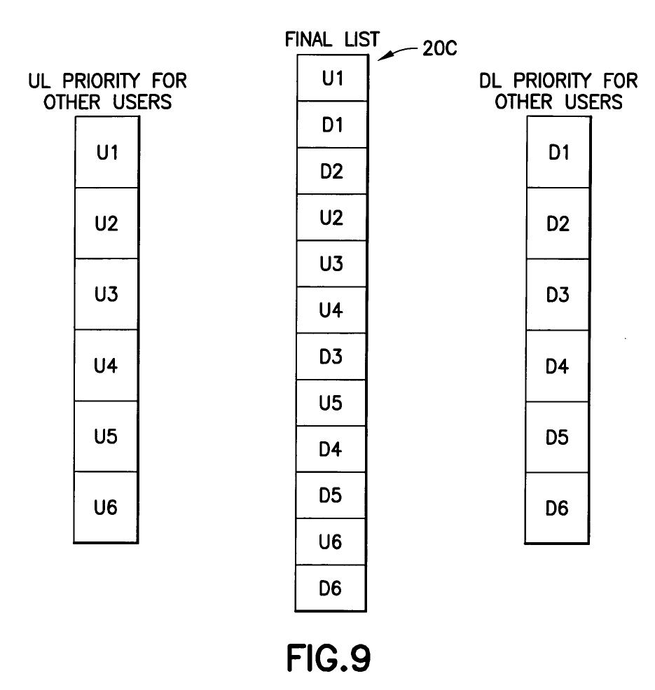

Referring to FIG. 9, another embodiment for other users employs a random allocation technique which gives priority to UL and DL UEs 10 randomly (or pseudo-randomly) for achieving fairness between the UL and DL users in the final list 20C.

To summarize, for retransmission UEs 10 the UL priority is made higher than the DL priority due to synchronous HARQ being more urgent than asynchronous HARQ, or the UL and DL priority lists are re-ordered globally in terms of retransmission number, where the highest retransmission number is given the highest priority. For delay sensitive UEs 10 there is a crossover between the same scheduling order for the UL and DL, where whether the UL UE 10 is scheduled first or the DL UE 10 is scheduled first is determined by the delay value, where the UE 10 having the largest delay is assigned the highest priority, or among all the UL and DL UEs 10 the most delay urgent user is identified and the user set which includes this user and those users with higher priority in the same direction (UL or DL) are scheduled first (and this procedure is repeated until all users are scheduled). For the other users case fairness is achieved by using one of the “zigzag” scheme or the random scheme to assign priorities to the UL and DL users.

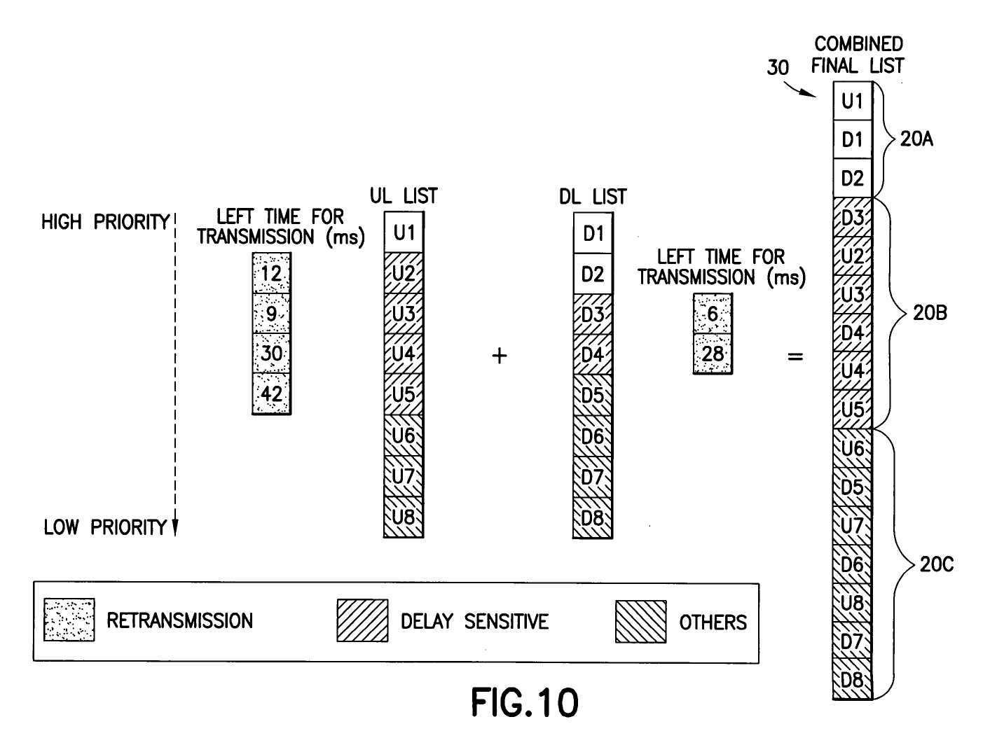

What follows is a description of one exemplary embodiment of a joint UL and DL priority list 30 that assumes the use of the first approach for retransmission users (UL priority is made higher than the DL priority). This exemplary embodiment also assumes the use of the second approach for delay sensitive users (the most delay urgent user is identified and the user set which includes this user and those users with higher priority in the same direction (UL or DL) are scheduled first). This exemplary embodiment also assumes the use of the first approach (zigzag that alternates between UL and DL users) for the other users. The application of these three non-limiting approaches to scheduling the UEs 10 results in the final list 30 shown in FIG. 10. Note that the retransmission users are scheduled first in the order U1, D1, D2, followed by the delay sensitive users in the order D3, U2, U3, D4, U4, U5, followed by the other users in the order U6, D5, U7, D6, U8, D7, D8. Note as well that the combined final list is comprised of the retransmission final list 20A, the delay sensitive final list 20B and the other user traffic final list 20C.

It is pointed out that the foregoing embodiment is illustrative of but one possible combination of approaches to achieve the joint UL and DL priority list 30, i.e., one that employs the first approach for retransmission users, the second approach for delay sensitive users and the first approach for the other users. In other embodiments of this invention other combinations of the approaches described above may be used. In still other embodiments of this invention one or more approaches that are similar to, or derived from, or that are different than the specific approach examples described above may be used to compose the joint UL and DL priority list 30.

As an exemplary technical effect, these exemplary embodiments thus consider the essential characteristic of each scheduling group (e.g., the nature of UL HARQ versus DL HARQ and possibly also the delay value) and provide an effective method to combine the UL and DL scheduling priorities. When a control channel is limited an enhanced VoIP performance can be achieved by the use of these exemplary embodiments.

Based on the foregoing it should be apparent that the exemplary embodiments of this invention provide a method, apparatus and computer program(s) to create a combined uplink and downlink prioritized list of users for scheduling purposes. The combined final uplink and downlink prioritized list of users 30 may be stored in the memory 12B, as shown in FIG. 2.

FIG. 11 is a logic flow diagram that illustrates the operation of a method, and a result of execution of computer program instructions, in accordance with the exemplary embodiments of this invention.

A) At Block 11A there is a step of creating a combined priority list that comprises both uplink users and downlink users ordered by priority (e.g., from lowest to highest or from highest to lowest), and at Block 11B there is a step of scheduling user transmissions based on their respective priority locations in the combined priority list.

B) In the method, and the result of execution of computer program instructions, of the preceding paragraph, where a first set of users are retransmission users, where a second set of users are delay sensitive users, and where a third set of users are other users that are neither retransmission users or delay sensitive users.

C) In the method, and the result of execution of computer program instructions, of the preceding paragraph, where the set of retransmission users has a higher priority than the set of delay sensitive users, which in turn has a higher priority than the set of other users.

D) In the method, and the result of execution of computer program instructions, of the preceding paragraph, further comprising assigning priorities to individual users within the set of retransmission users so as to assign all uplink users a higher priority than downlink users.

E) In the method, and the result of execution of computer program instructions, of the preceding paragraph D), further comprising assigning priorities to individual users within the set of retransmission users so as to assign a highest priority to a user that has a largest retransmission count, and to assign a second highest priority to a user having a second largest retransmission count, and continuing until all uplink and downlink retransmission users are assigned.

F) In the method, and the result of execution of computer program instructions, of the preceding paragraph C), further comprising assigning priorities to individual users within the set of delay sensitive users so as to assign a highest priority to one of a pair of equal priority uplink and downlink users that has a least amount of time remaining before transmission is to occur, and assigning the second highest priority to the other user of the pair, and continuing until all pairs of equal priority uplink and downlink delay sensitive users are assigned.

G) In the method, and the result of execution of computer program instructions, of the preceding paragraph C), further comprising assigning priorities to individual users within the set of delay sensitive users by selecting an uplink or a downlink user that has a least amount of time remaining before transmission is to occur, and assigning a highest priority to a group of users that comprise the selected user and all users, if any, having a higher priority than the selected user in either an uplink or a downlink priority list from which the user was selected, and continuing until all users and groups of delay sensitive users are assigned.

H) In the method, and the result of execution of computer program instructions, of the preceding paragraph C), further comprising assigning priorities to individual users within the set of other users in an alternating fashion by first selecting a highest priority user from one of a first one of an uplink or a downlink priority list, then by selecting a highest priority user from the other one of the uplink or the downlink priority list, then by selecting a second highest user from the first one of the uplink or the downlink priority list, then by selecting the second highest priority user from the other one of the uplink or the downlink priority list, and continuing until all uplink and downlink users from the set of other users are assigned.

I) In the method, and the result of execution of computer program instructions, of the preceding paragraph C), further comprising assigning priorities to individual users within the set of other users by first randomly selecting a highest priority user from either one of an uplink or a downlink priority list, then by selecting a highest priority user from the other one of the uplink or the downlink priority list, then by randomly selecting a second highest user from either one of the uplink or the downlink priority list, then by selecting the second highest priority user from the other one of the uplink or the downlink priority list, and continuing until all uplink and downlink users from the set of other users are assigned.

The various blocks shown in FIG. 11 may be viewed as method steps, and/or as operations that result from operation of computer program code, and/or as a plurality of coupled logic circuit elements constructed to carry out the associated function(s), such as the RRM SF 12E shown in FIG. 2.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the EUTRAN (UTRAN-LTE) system, it should be appreciated that the exemplary embodiments of this invention are not limited for use with only this one particular type of wireless communication system, and that they may be used to advantage in other wireless communication systems. For example, while the exemplary embodiments may be used in the Release 8 version of LTE, they may also be used in subsequent versions and releases, including LTE-Advanced (LTE-A) systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, any names used for the described parameters are not intended to be limiting in any respect, as these parameters may be identified by any suitable names. Further, the various names assigned to different channels and procedures (e.g., HARQ, VoIP) are not intended to be limiting in any respect, as these various channels and procedures may be identified by any suitable names. Further, these exemplary embodiments are not limited for use only with scheduling delay sensitive packet traffic for VoIP users, but may applied as well to other types of delay sensitive traffic (e.g., such as for certain types of streaming media packet traffic). Furthermore, in other embodiments more or less than three categories of users may be considered, i.e., more or less than the three categories of retransmission, delay sensitive and other users. Furthermore, in other embodiments of this invention one or more of these user categories may be partitioned into sub-categories, e.g., the delay sensitive users may be distinguished as VoIP users and as streaming media users, as one non-limiting example, and scheduled separately.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
creating a combined priority list that comprises both uplink users and downlink users ordered by priority; and
scheduling user transmissions based on their respective priority locations in the combined priority list.

2. The method of claim 1, where a first set of users are retransmission users, where a second set of users are delay sensitive users, and where a third set of users are other users that are neither retransmission users or delay sensitive users.

3. The method of claim 2, where the set of retransmission users has a higher priority than the set of delay sensitive users, which in turn has a higher priority than the set of other users.

4. The method of claim 3, further comprising assigning priorities to individual users within the set of retransmission users so as to assign all uplink users a higher priority than downlink users.

5. The method of claim 3, further comprising assigning priorities to individual users within the set of retransmission users so as to assign a highest priority to a user that has a largest retransmission count, and to assign a second highest priority to a user having a second largest retransmission count, and continuing until all uplink and downlink retransmission users are assigned.

6. The method of claim 3, further comprising assigning priorities to individual users within the set of delay sensitive users so as to assign a highest priority to one of a pair of equal priority uplink and downlink users that has a least amount of time remaining before transmission is to occur, and assigning the second highest priority to the other user of the pair, and continuing until all pairs of equal priority uplink and downlink delay sensitive users are assigned.

7. The method of claim 3, further comprising assigning priorities to individual users within the set of delay sensitive users by selecting an uplink or a downlink user that has a least amount of time remaining before transmission is to occur, and assigning a highest priority to a group of users that comprise the selected user and all users, if any, having a higher priority than the selected user in either an uplink or a downlink priority list from which the user was selected, and continuing until all users and groups of delay sensitive users are assigned.

8. The method of claim 3, further comprising assigning priorities to individual users within the set of other users in an alternating fashion by first selecting a highest priority user from one of a first one of an uplink or a downlink priority list, then by selecting a highest priority user from the other one of the uplink or the downlink priority list, then by selecting a second highest user from the first one of the uplink or the downlink priority list, then by selecting the second highest priority user from the other one of the uplink or the downlink priority list, and continuing until all uplink and downlink users from the set of other users are assigned.

9. The method of claim 3, further comprising assigning priorities to individual users within the set of other users by first randomly selecting a highest priority user from either one of an uplink or a downlink priority list, then by selecting a highest priority user from the other one of the uplink or the downlink priority list, then by randomly selecting a second highest user from either one of the uplink or the downlink priority list, then by selecting the second highest priority user from the other one of the uplink or the downlink priority list, and continuing until all uplink and downlink users from the set of other users are assigned.

10. A computer-readable medium that stores computer program instructions, the execution of which result in operations that comprise:
creating a combined priority list that comprises both uplink users and downlink users ordered by priority; and
scheduling user transmissions based on their respective priority locations in the combined priority list.

11. The computer-readable medium of claim 10, where a first set of users are retransmission users, where a second set of users are delay sensitive users, and where a third set of users are other users that are neither retransmission users or delay sensitive users.

12. The computer-readable medium of claim 11, where the set of retransmission users has a higher priority than the set of delay sensitive users, which in turn has a higher priority than the set of other users.

13. The computer-readable medium of claim 12, further comprising assigning priorities to individual users within the set of retransmission users so as to assign all uplink users a higher priority than downlink users.

14. The computer-readable medium of claim 12, further comprising assigning priorities to individual users within the set of retransmission users so as to assign a highest priority to a user that has a largest retransmission count, and to assign a second highest priority to a user having a second largest retransmission count, and continuing until all uplink and downlink retransmission users are assigned.

15. The computer-readable medium of claim 12, further comprising assigning priorities to individual users within the set of delay sensitive users so as to assign a highest priority to one of a pair of equal priority uplink and downlink users that has a least amount of time remaining before transmission is to occur, and assigning the second highest priority to the other user of the pair, and continuing until all pairs of equal priority uplink and downlink delay sensitive users are assigned.

16. The computer-readable medium of claim 12, further comprising assigning priorities to individual users within the set of delay sensitive users by selecting an uplink or a downlink user that has a least amount of time remaining before transmission is to occur, and assigning a highest priority to a group of users that comprise the selected user and all users, if any, having a higher priority than the selected user in either an uplink or a downlink priority list from which the user was selected, and continuing until all users and groups of delay sensitive users are assigned.

17. The computer-readable medium of claim 12, further comprising assigning priorities to individual users within the set of other users in an alternating fashion by first selecting a highest priority user from one of a first one of an uplink or a downlink priority list, then by selecting a highest priority user from the other one of the uplink or the downlink priority list, then by selecting a second highest user from the first one of the uplink or the downlink priority list, then by selecting the second highest priority user from the other one of the uplink or the downlink priority list, and continuing until all uplink and downlink users from the set of other users are assigned.

18. The computer-readable medium of claim 12, further comprising assigning priorities to individual users within the set of other users by first randomly selecting a highest priority user from either one of an uplink or a downlink priority list, then by selecting a highest priority user from the other one of the uplink or the downlink priority list, then by randomly selecting a second highest user from either one of the uplink or the downlink priority list, then by selecting the second highest priority user from the other one of the uplink or the downlink priority list, and continuing until all uplink and downlink users from the set of other users are assigned.

19. An apparatus, comprising:
a controller configured to create a combined priority list that comprises both uplink users and downlink users ordered by priority for use in scheduling user transmissions based on their respective priority locations in the combined priority list.

20. The apparatus of claim 19, where a first set of users are retransmission users, where a second set of users are delay sensitive users, and where a third set of users are other users that are neither retransmission users or delay sensitive users.

21. The apparatus of claim 20, where the set of retransmission users has a higher priority than the set of delay sensitive users, which in turn have a higher priority than the set of other users.

22. The apparatus of claim 21, said controller being further configured to assign priorities to individual users within the set of retransmission users so as to assign all uplink users a higher priority than downlink users.

23. The apparatus of claim 21, said controller being further configured to assign priorities to individual users within the set of retransmission users so as to assign a highest priority to a user that has a largest retransmission count, and to assign a second highest priority to a user having a second largest retransmission count, and to continue until all uplink and downlink retransmission users are assigned.

24. The apparatus of claim 21, said controller being further configured to assign priorities to individual users within the set of delay sensitive users so as to assign a highest priority to one of a pair of equal priority uplink and downlink users that has a least amount of time remaining before transmission is to occur, to assign the second highest priority to the other user of the pair, and to continue until all pairs of equal priority uplink and downlink delay sensitive users are assigned.

25. The apparatus of claim 21, said controller being further configured to assign priorities to individual users within the set of delay sensitive users by selecting an uplink or a downlink user that has a least amount of time remaining before transmission is to occur, and to assign a highest priority to a group of users that comprise the selected user and all users, if any, having a higher priority than the selected user in either an uplink or a downlink priority list from which the user was selected, and to continue until all users and groups of delay sensitive users are assigned.

26. The apparatus of claim 21, said controller being further configured to assign priorities to individual users within the set of other users in an alternating fashion by first selecting a highest priority user from one of a first one of an uplink or a downlink priority list, then to select a highest priority user from the other one of the uplink or the downlink priority list, then to select a second highest user from the first one of the uplink or the downlink priority list, then to select the second highest priority user from the other one of the uplink or the downlink priority list, and to continue until all uplink and downlink users from the set of other users are assigned.

27. The apparatus of claim 21, said controller being further configured to assign priorities to individual users within the set of other users by first randomly selecting a highest priority user from either one of an uplink or a downlink priority list, then to select a highest priority user from the other one of the uplink or the downlink priority list, then to randomly select a second highest user from either one of the uplink or the downlink priority list, then to select the second highest priority user from the other one of the uplink or the downlink priority list, and to continue until all uplink and downlink users from the set of other users are assigned.

28. The apparatus of claim 19, embodied at least partially in at least one integrated circuit.

29. The apparatus of claim 19, embodied in a base station of a wireless communication system.

30. The apparatus of claim 19, further comprising a memory configured to store the combined priority list.

31. An apparatus, comprising:
means for establishing a first priority list for a first set of users that are retransmission users, for establishing a second priority list for a second set of users that are delay sensitive users, and for establishing a third priority list for a third set of users that are neither retransmission users or delay sensitive users;
means for creating from the first, second and third priority lists a combined priority list that comprises both uplink users and downlink users ordered by priority.

32. The apparatus of claim 31, where the set of retransmission users has a higher priority than the set of delay sensitive users, which in turn have a higher priority than the set of other users.

33. The apparatus of claim 31, further comprising means for scheduling user transmissions based on their respective priority locations in the combined priority list.

34. The apparatus of claim 31, embodied at least partially in at least one integrated circuit.

35. The apparatus of claim 31, embodied in a base station of a wireless communication system.
